(19) United States
(12) Patent Application Publication
(10) Pub. No.: US 2002/0039099 A1
(43) Pub. Date: Apr. 4, 2002

(54) Method and apparatus for simultaneous image capture and image display in an imaging device

(75) Inventor: Jeffrey D. Harper, Charlotte, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Hand Held Products, Inc., Charlotte, NC

(21) Appl. No.: 09/966,970

(22) Filed: Sep. 28, 2001

Related U.S. Application Data
(60) Provisional application No. 60/237,061, filed on Sep. 30, 2000.

(51) Int. Cl. G09G 5/399; G06F 13/00

(52) U.S. Cl. 345/539; 345/536; 345/537

(57) ABSTRACT

An imaging device and a method for implementing simultaneous image capture and image display update in an imaging device are provided. The imaging device of the present invention implements first and second image capture buffers within a memory module such that a first buffer captures image data from the imager while the second buffer displays the image on the imaging device display. A method for simultaneous image capture and image display update comprises capturing first-in-time image data to a first image capture buffer that is in communication with an imager, capturing second-in-time image data to a second image capture buffer that is in communication with an imager and displaying the first-in-time image data on a display while the image device captures the second-in time image data to the second image capture buffer.

### CROSS-REFERENCE TO RELATED APPLICATIONS

The present application claims priority from U.S. Provisional Patent Application Serial No. 60/237,061, entitled Method and Apparatus for Double Buffering for Simultaneous Display Update/Image Capture and Fully Duplex Transmission filed on Sep. 30, 2000, the contents of which are herein incorporated by reference.

### FIELD OF THE INVENTION

The present invention relates generally to processing of image data in an imaging system and, more particularly, to a method and apparatus for providing simultaneous image capture and image display processing in an imager device through the implementation of a dual capture buffers.

### BACKGROUND OF THE INVENTION

Portable imaging devices such as bar code readers, optical character readers, digital cameras and the like have come into widespread use in large numbers of retail, industrial and medical applications. Such imaging devices are used to perform routine data entry functions such as pricing, inventory control, etc., with an accuracy and reliability that far exceeds that of manual data entry. These and other advantages, such as high data throughput rates and direct compatibility with data processing devices and systems, assures that imaging devices will become more prevalent in the future. As the use of such devices increases the demands on the devices will increase as well. These demands will dictate that the portable imaging devices of the future read, record and decode ever-increasing quantities and densities of optically encoded data.

It is desirable to make portable imaging devices more convenient and user-friendly. In this regard, current imaging devices are limited by image update rates that may require the user to move or re-position the imager, wait for a display and incur a frustrating delay. If that delay is long enough there is a tendency on the part of the user to overshoot; the user continues to move the device with the aspiration of obtaining the desired image on the display when in fact the desired image has already passed.

In accordance with the prior art, FIG. 1 is a simplified block diagram of portable imaging device hardware and software modules. The imaging device 10 includes an imager 20 that is controlled by the central processing unit 30. The central processing unit issues capture commands to the imager via direct memory access (DMA) module 40. In the embodiment shown the DMA module is implemented within a field programmable gate array (FPGA) 50, however the DMA module may also be implemented in other devices. The imager 20 captures images and the DMA module stores the image in memory module 60. An image capture buffer 70 within the memory module stores the image data prior to displaying the image on a display, such as liquid crystal display (LCD) 80.

As shown in the timeline of FIG. 2, a typical imaging device will capture 30 frames per second or one frame every 33 milliseconds. This is commonly referred to as the image capture cycle (i.e. the time required for the imager to expose the image and ship the data to memory). In the timeline of FIG. 2, the image capture cycle is 33 milliseconds, meaning that once every 33 milliseconds the imager exposes a new frame and sends this image to memory. In prior art imaging devices if a command to capture an image is issued while the imager is in the middle of displaying an image, the next image capture routine will commence once a new image capture cycle begins.

FIG. 3 is a flow diagram of the image capture and image display routine in a conventional imaging device, in accordance with the prior art. At step 100, the imaging device captures an image by exposing the image and directing the image to the image capture buffer within the memory module. As discussed in the preceding paragraph this is referred to as the image capture cycle and in many imaging devices the cycle lasts 33 milliseconds. This process ensues when a command is issued from the CPU that instructs the DMA to capture an image. Once the image is captured, the image may undergo time intensive preprocessing prior to displaying the image. Pre-processing may entail, at optional steps 110 and 120, enhancing the image and reformatting the image. Enhancement may include adjustment of the image contrast or sharpening the image, typically by implementing a filtering scheme. Reformatting may include adjusting the size of the image or the pixel depth (i.e. 8/bits/pixel captured versus 4 bits/pixel displayed). After the preprocessing stages are concluded, at step 130 the image is painted on the display. At step 140 a decision is made as to whether the capture and display process is to continue (i.e. another command to capture is sent to the imager) or whether, at 150, the capture routine is to be completed. The decision as to whether to continue capturing images is typically dictated by the user of the imaging device. It may also be possible to invoke this decision by other manual or automated means.

As previously discussed in traditional imaging devices when a subsequent capture command is issued to the imager it will be issued while the imager is in the process of an image capture cycle and thus the actual capture of a frame will not begin until a new image capture cycle commences. This occurs because the pre-processing and painting routines described above occur at the same time the imager is processing the next image capture cycle.

For example, in a known imaging device it can be assumed that the captured image is frame n. When the end of frame signal arrives to let the device know that the image has been captured, the device initiates the pre-processing stages, such as enhancement and reformatting and paints the image on the display. In a typical known imaging device this process would consume about 10 to about 20 milliseconds. Once the painting process is completed, the device issues a command to capture the next image. Due to the time required to pre-process and paint the image, it is not possible to capture frame n+1 because the imager would have already begun the image capture cycle for the n+1 frame. Therefore, the imaging device begins the capture routine of frame n+2 when the next image capture cycle begins. The effect is that the n+1 frame and every other odd numbered frame in the equation (e.g. n+3, n+5, etc.) is omitted from being displayed. This results in only about 15 frames per second being painted on the display during the aiming routine.

Therefore, a need exists to develop an imaging device that will improve the speed at which images are updated on imaging device displays. In this regard, such a device will provide the capability to display every frame that the imager is capable of capturing. Such an imaging device would overcome the current imaging device limitation of only being able to display, in a best case scenario, every other frame that the imager is capable of capturing. By providing for an image device that updates and displays every frame that imager is capable of capturing, the user of the imaging device benefits from a more efficient device in which real-time aiming/capture can be realized. Such an imaging device would lessen the likelihood of the user overshooting, i.e. continuing to move the device with the aspiration of obtaining the desired image on the display when in fact the desired image has already passed.

### SUMMARY OF THE INVENTION

The invention provides for an imaging device and associated methods for simultaneously capturing image data and image display update. The invention implements first and second buffers (i.e., dual or double buffers) that are capable of capturing an image in one buffer while a second buffer displays the image on an associated imaging device display. This provides for overall efficiency in the use of the device, in that the imaging device and method provide the capability to capture and display every frame that the imager processes. Such a device benefits from real-time aiming, capture and display of image data.

In a first embodiment of the invention an imaging device for simultaneous image capture and image display updating is provided. The device includes an imager for capturing image data upon aiming the imager at the desired image to be captured. A central processing unit (CPU) is included that is in communication with the imager and issues commands to capture image data. The device also includes a direct memory access (DMA) module in communication with the imager and the CPU that queues requests from the CPU to capture image data and sends the requests to the imager once an end of frame signal is received. Instrumental in implementing the simultaneous image capture and display of the present invention is the memory module that is in communication with the CPU and the DMA module and includes a first image capture and a second image capture buffer. The image capture buffers temporarily store captured image data prior to displaying the image data. In this regard, the first image capture buffer will capture image data from the imager while the CPU displays the image data that resides in the second image capture buffer. This is an iterative process, such that once the second image capture buffer displays the image data, the second image capture buffer can then capture new image data while the first image buffer displays image data to the imaging device display.

In alternate embodiments of the invention the imaging device may further include a field programmable gate array (FPGA) device that implements the direct memory access (DMA) module. In addition, means for enhancing the image data stored in the buffers and means for reformatting the image data stored in the buffers may also be provided for within the imaging device. In the instance where means for enhancing or reformatted are provided for, an image display buffer may be implemented that stores the image data after enhancement/reformatting and prior to image display.

The invention is further embodied in a method for simultaneously capturing image data and updating image display data. The method includes the steps of capturing first-in-time image data to a first image capture buffer that is in communication with an imager and capturing second-in-time image data to a second image capture buffer that is in communication with an imager. In conjunction with the capture routines, the method includes displaying the first-in-time image data on a display while the image device captures the second-in time image data to the second image capture buffer.

In a further method embodiment additional steps for the include capturing third-in-time image data to the first buffer once the first-in-time image data is displayed. The displaying of the image in the first buffer coincides with the first buffer becoming available for new image data capture. Additionally the method may include the step of displaying the second-in-time image data on a display while the image device captures the third-in-time image data to the first buffer.

In alternate methods of the invention, the method may include enhancing and or reformatting the image data after capture to the image capture buffer and before displaying the image data on the display. These additional pre-processes may require the step of temporarily storing the image data, post pre-processing, in an image capture buffer prior to image display updating. The additional image capture buffer simplifies the implementation of image processing algorithms by providing for separate by buffers for the input of the algorithm and the output of the algorithm.

In yet another embodiment of the invention, a method for simultaneous image capture and image display in an imaging device includes the steps of issuing a first command to capture first-in-time image data to a first image capture buffer and issuing a second command to capture second-in-time image data to a second image capture buffer. Once these commands have been issued the imager and first buffer execute the first capture command and signal an end-of-frame upon completion of the capture process. A third capture command is then issued to capture third-in-time image data to the first image capture buffer. Once this command has been issued the imager and second buffer execute the second capture command. While the second capture command is executed; the first-in-time image data is displayed on an imaging device display.

As previously described, alternate embodiments of this method may include enhancing and or reformatting the image data after capture to the image capture buffers and before displaying the image data on the display. Temporary storage of the image, post pre-processing, may be implemented in an image capture buffer prior to image display updating.

Such devices and methods briefly described above and at length below serve to improve the speed at which images are updated on imaging device displays. In this regard, such a device provides the capability to display every frame that the imager is capable of capturing. The imaging device and associated methods overcome the current imaging device limitation of only being able to display, in a best case scenario, every other frame that the imager is capable of capturing. The imaging device user benefits from a more efficient device in which real-time aiming/capture can be realized.

### BRIEF DESCRIPTION OF THE DRAWINGS

FIG. 1 is a block diagram of imaging device hardware and software modules, in accordance with the prior art.

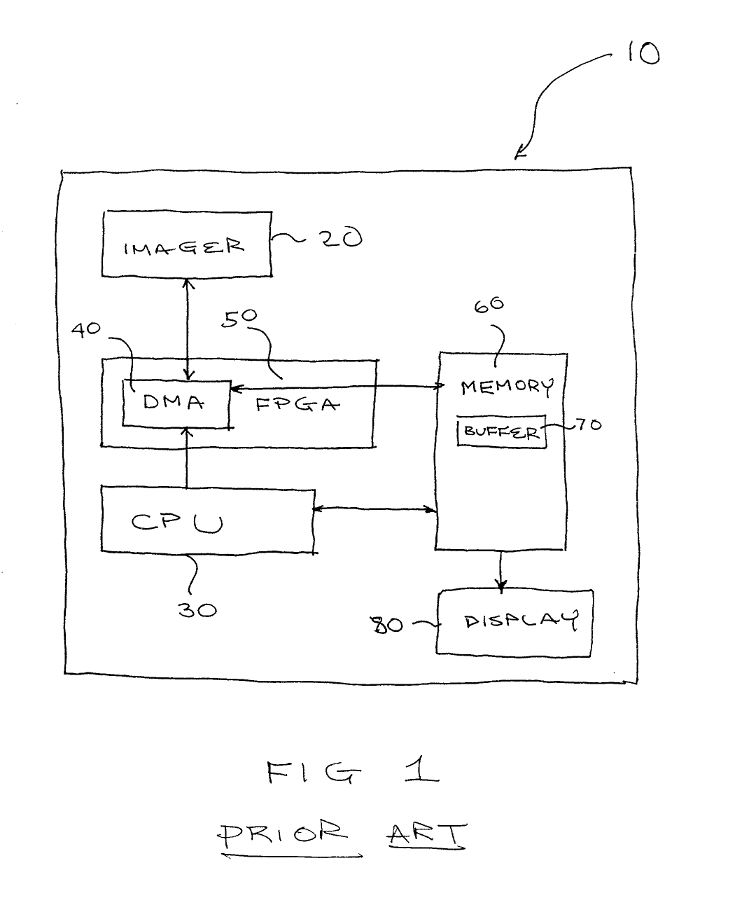

FIG. 2 is a timeline indicating a standard time segments for image capture cycles.

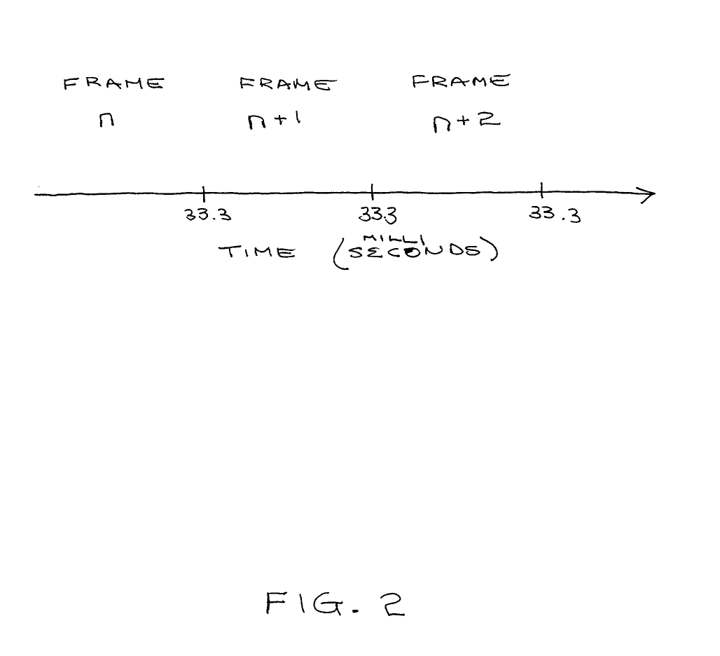

FIG. 3 is a flow diagram of a method for image capture and image display, in accordance with the prior art.

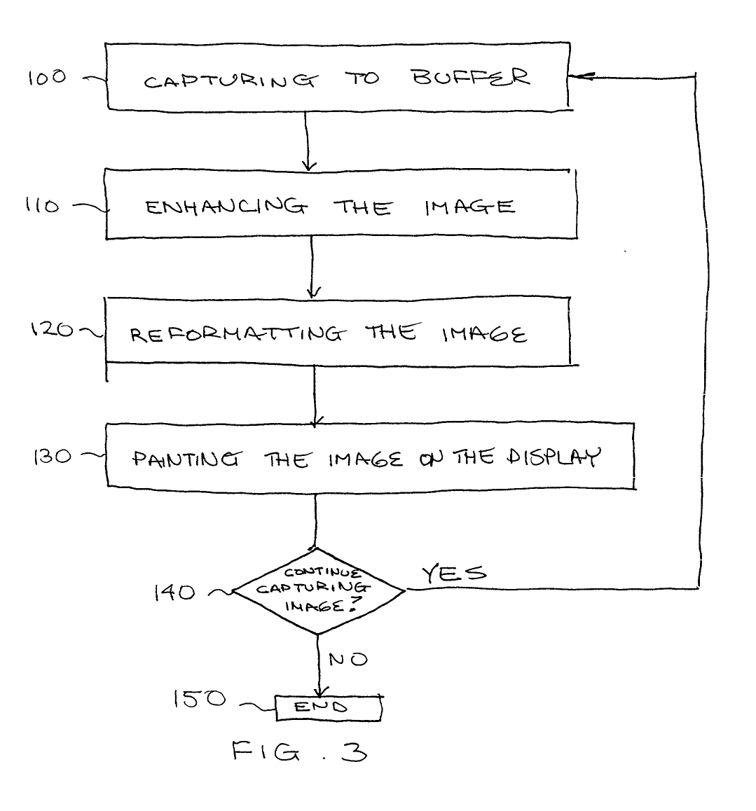

FIG. 4 is a block diagram of imaging device hardware and software modules that implement simultaneous image capture and image display update, in accordance with an embodiment of the present invention

FIG. 5 is a flow diagram of a simplified method for simultaneous image capture and image display update, in accordance with another embodiment of the present invention.

FIG. 6 is a flow diagram of one specific embodiment for simultaneous image capture and image display update, in accordance with an embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

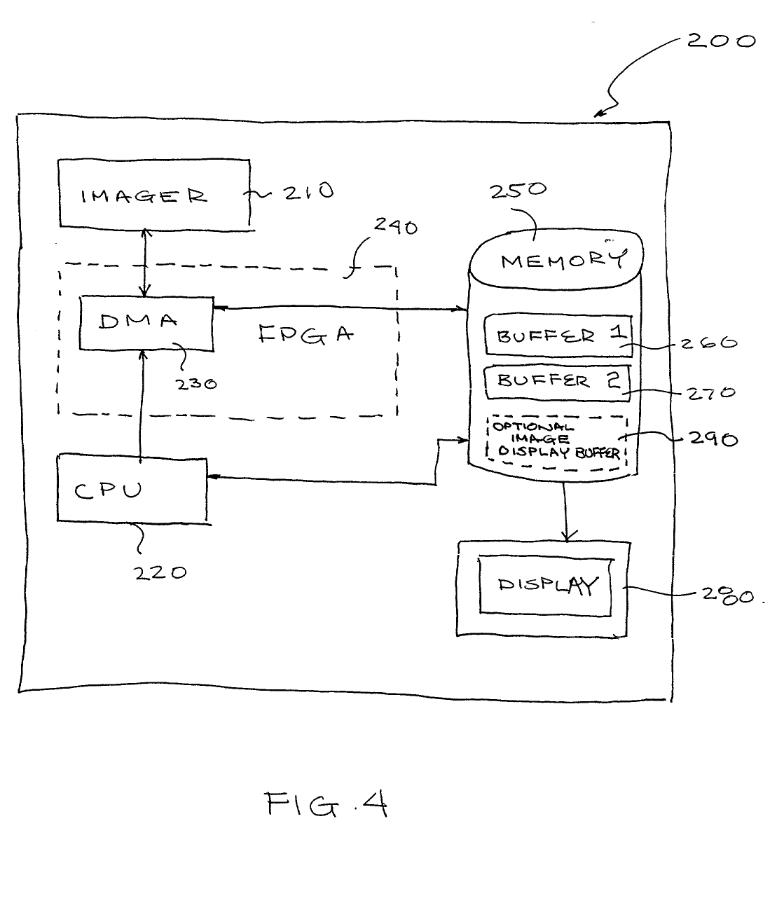

FIG. 4 provides for a block diagram of an imaging device having the capability to capture images and update the display of images simultaneously, in accordance with the present invention. The imaging device described herein utilizes double buffering within the memory module for simultaneous display update and image capture. Double buffering serves to increases the rate that images are painted to the display during the aiming process.

The imaging device 200 includes an imager 210 that is controlled by the central processing unit 220. The central processing unit issues capture commands to the imager via direct memory access (DMA) module 230. In the embodiment shown the DMA module is implemented within a field programmable gate array (FPGA) 240, however the DMA module may also be implemented in other devices. The DMA module provides the capability to queue multiple capture commands. In this regard, when the DMA receives an end of frame signal from the imager, it executes the next capture command in the queue if there is another command in the queue. The DMA module 230 captures images and stores the image in memory module 250. A first image capture buffer 260 and a second image capture buffer 270 within the memory module stores the image data prior to displaying the image on a display, such as liquid crystal display (LCD) 280. In some embodiments, optional image display buffer 290 will be implemented. The optional image display buffer temporarily stores the image after pre-processing (i.e., enhancement and/or reformatting) prior to transferring the image to the image device display.

In accordance with the present invention, the simultaneous image capture and image updating method provides for an additional capture command being issued to capture frame n+1 to a second buffer prior to painting frame n. The second buffer is required because the first buffer is occupied by the image that is being painted, n. The second buffer provides for temporary storage of the next image, n+1.

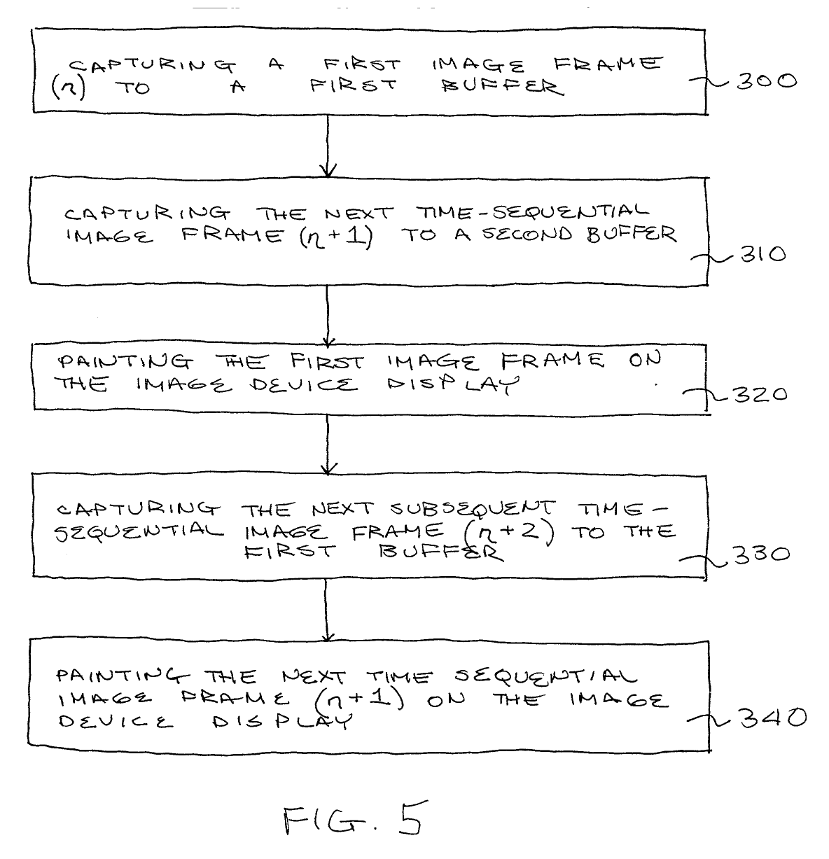

FIG. 5 is a flow diagram that details a simplified method for simultaneous image capture and image display updating in an imaging device, in accordance with an embodiment of the present invention. At step 300, a first image frame (n) is captured by an imaging device and is stored in a first buffer. At step 310, the next time-sequential image frame (n+1) that the imaging device processes is captured and stored in a second buffer. While the imaging device is capturing the next time-sequential image frame (n+1), the first image, at step 320, is being painted on the image device display. Once the first image is painted on the display, the first buffer becomes available and, at step 330, the next time-sequential image frame (n+2) can be captured to the first buffer. While the imaging device is capturing the n+2 image frame, the n+1 image frame, at step 340, is being painted on the image device display. This is an iterative process that proceeds as long as capture commands are being transmitted to the imager associated with the imaging device.

It should be noted that the use of n, n+1, and n+2 designators is for the purpose of describing a preferred method of simultaneous image capture and image updating display. It is possible that in certain embodiments of the method described herein, the method will not provide for the display updating of every image frame that the imager views. If the time required for enhancement, reformatting, and painting is longer than the frame time (usually 33 ms), then the display of certain frames will be skipped.

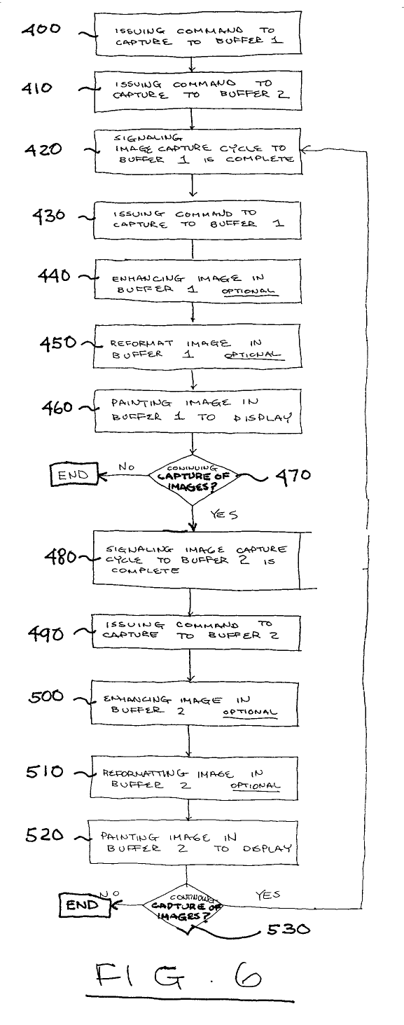

FIG. 6 is a flow diagram that details one embodiment of a method for simultaneous image capture and image display updating in an imaging device, in accordance with an embodiment of the present invention. At step 400, a command is issued by the central processing unit (CPU) of the imaging device to capture an image frame (n) to buffer 1. The DMA controller of the imaging device executes the command and begins the image capture cycle of frame n to buffer 1. At step 410, a command is issued by the CPU of the imaging device to capture the next time-sequential image frame (n+1). As previously discussed the DMA module provides the capability to queue the capture command, as such, the command to capture the n+1 image frame is executed by the DMA controller after the image capture cycle of image frame n has been completed. At step 420, an end of frame (EOF) signal is sent from the imager to the CPU notifying the CPU that image capturing cycle of frame n has been completed. Once the EOF signal has been received by the CPU, at step 430, a command is issued by the CPU instructing the DMA module to capture the next time-sequential image frame (n+2) to the first buffer. The command to capture the n+2 image frame is executed by the DMA controller after the image capture cycle of image frame n+1 has been completed and the image in buffer 1 has been painted on the imaging device display.

At optional step 440, enhancing the image frame (n) in buffer 1 ensues. Enhancing the image frame will typically comprise adjusting the contrast of the image and/or sharpening the image by implementing a high pass filtering procedure. At optional step 450, reformatting the image frame (n) in buffer 1 ensues. Reformatting the image frame will typically include re-sizing the image to accommodate the display of the imaging device. At step 460, the image frame (n) in buffer 1 is painted on the imaging device display. In certain imaging devices the image stored in the buffer will not require pre-processing (i.e., enhancing and/or reformatting) prior to painting the image on the imaging device display and the painting of the image frame on the display will commence once the image frame is placed in the buffer.

At decision block 470, a decision is made whether to continue capturing images or whether to end the image capture routine. The decision as to whether capturing of images continues is typically dictated by the user of the imaging device. It may also be possible to invoke this decision by other manual or automated means. Once a decision is made to continue capturing image frames, at step 480, an EOF signal is sent from the imager to the CPU notifying the CPU that image capturing cycle of image frame n+1 has been completed. It should be understood that the image capturing cycle of image frame n+1 is undertaken while image frame n is undergoing pre-processing (steps 440 and 450) and the process of painting the image on the display (step 460). Once the EOF signal has been received by the CPU, at step 490, a command is issued by the CPU instructing the DMA module to capture the next time-sequential image frame (n+3) to the second buffer. The command to capture the n+3 image frame is executed by the DMA controller after the image capture cycle of image frame n+2 has been completed and the image in buffer 2 has been painted on the imaging device display.

At optional step 500, enhancing the image frame (n+1) in buffer 2 ensues and, at optional step 510, reformatting the image frame (n+1) in buffer 2 ensues. At step 520, the image frame (n+1) in buffer 2 is painted on the imaging device display. At decision block 530, a decision is made whether to continue the image capture process or whether to end the routine. If the decision is made to continue the image capture routine then the iterative process ensues whereby the flow returns to step 420, where the CPU awaits the EOF signal from the imager before, at step 430, issuing a command to the imager to capture to buffer 1.

The imaging device and method of the present invention provides for simultaneous image capture and image display update. These devices and methods improve the speed at which images are updated on imaging device displays. In this regard, the device and associated methods will provide the capability to display every frame that the imager is capable of capturing. Such an imaging device overcomes the current imaging device limitation of only being able to display, in a best case scenario, every other frame that the imager is capable of capturing. By providing for an image device that updates and displays every frame that an imager is capable of capturing, the user of the imaging device benefits from a more efficient device in which real-time aiming/capture can be realized. The imaging device of the present invention lessens the likelihood of the user overshooting, i.e. continuing to move the device with the aspiration of obtaining the desired image on the display when in fact the desired image has already passed.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An imaging device for simultaneous image capture and image display updating, the device comprising:
an imager for capturing image data upon aiming the imager at an image;
a central processing unit (CPU) that is in communication with the imager and issues commands to capture image data;
a direct memory access module in communication with the imager and the CPU that executes the commands to capture image data; and
a memory module in communication with the CPU and the DMA module, the memory module including a first image capture buffer that temporarily stores first-in-time captured image data prior to displaying first-in-time image data and a second image capture buffer that temporarily stores second-in-time captured image data prior to displaying second-in-time image data.

2. The image device of claim 1, further comprising a display that displays to a user first-in-time image data followed by the display of second-in-time image data.

3. The image device of claim 1, further comprising a field programmable gate array device that implements the direct memory access (DMA) module.

4. The image device of claim 1, further comprising a means for enhancing image data stored in the first and second image capture buffers.

5. The image capture device of claim 1, further comprising a means for reformatting image data stored in the first and second image capture buffers.

6. The image device of claim 4, wherein the memory module further includes an image display buffer that temporarily stores captured image data that has been enhanced prior to display.

7. A method for simultaneous image capture and image display in an imaging device, the method comprising the steps of:
capturing first-in-time image data to a first image capture buffer that is in communication with an imager;
capturing second-in-time image data to a second image capture buffer that is in communication with an imager; and
displaying the first-in-time image data on a display while the image device captures the second-in time image data to the second image capture buffer.

8. The method of claim 7, further comprising the steps of:
capturing third-in-time image data to the first buffer once the first-in-time image data is displayed; and
displaying the second-in-time image data on a display while the image device captures the third-in-time image data to the first buffer.

9. The method of claim 7, wherein capturing first-in-time image data to a first image capture buffer, further comprises the step of:
issuing, at a CPU, a capture command to a DMA module to capture first-in-time image data to the first image capture buffer;
queuing, at the DMA module, the capture command until the DMA module receives an end-of-frame signal;
executing, at the DMA module, the capture command to capture first-in-time image data to the first image capture buffer; and
transferring the first-in-time image data from the imager to the first image capture buffer.

10. The method of claim 7, wherein capturing second-in-time image data to a second image capture buffer, further comprises the step of:
issuing, at a CPU, a capture command to a DMA module to capture second-in-time image data to the second image capture buffer;
queuing, at the DMA module, the capture command until the DMA module receives an end-of-frame signal;
executing, at the DMA module, the capture command to capture second-in-time image data to the second image capture buffer; and
transferring the second-in-time image data from the image to the second image capture buffer.

11. The method of claim 7, further comprising the step of enhancing the first-in-time image data after capture to the first image capture buffer and before displaying the first-in-time image data on the display.

12. The method of claim 7, further comprising the step of re-formatting the first-in-time image data after capture to the first image capture buffer and before displaying the first-in-time image data on the display.

13. The method of claim 7, further comprising the steps of enhancing the first-in-time image data after capture to the first image capture buffer and before displaying the first-in-time image data on the display and re-formatting the first-in-time image data after capture to the first image capture buffer and before displaying the first-in-time image data on the display.

14. The method of claim 8, wherein the step of capturing third-in-time image data to the first buffer once the first-in-time image data is displayed, further comprises the steps of:
issuing, at a CPU, a capture command to a DMA module to capture third-in-time image data to the second image capture buffer in response to an EOF signal;
queuing, at the DMA module, the capture command until the DMA module receives an EOF signal;
executing, at the DMA module, the capture command to capture third-in-time image data to the first image capture buffer; and
transferring the third-in-time image data from the imager to the first image capture buffer.

15. A method for simultaneous image capture and image display in an imaging device, the method comprising the steps of:
issuing a first command to capture first-in-time image data to a first image capture buffer;
issuing a second command to capture second-in-time image data to a second image capture buffer;
executing the first capture command;
signaling end-of-frame (EOF) upon the completion of capturing the first-in-time image data to the first image capture buffer;
issuing a third command to capture third-in-time image data to the first image capture buffer;
executing the second capture command; and
displaying the first-in-time image data to an imaging device display while the imager executes the second command to capture second-in-time image data to the second image capture buffer.

16. The method of claim 15, further comprising the steps of:
signaling end-of-frame (EOF) upon the completion of capturing the second-in-time image data to the second image capture buffer;
issuing a fourth command to capture fourth-in-time image data to the second image capture buffer;
executing the third capture command; and
displaying the second-in-time image data to the imaging device display while the imager executes the third command to capture third-in-time image data to the first image capture buffer.

17. The method of claim 15, further comprising the step of enhancing the first-in-time image data that is stored in the first image capture buffer prior to displaying the first-in-time image data on the image device display.

18. The method of claim 17, further comprising the step of storing the enhanced first-in-time iagme data in an image display buffer prior to displaying the first-in-time image data on the image device display.

19. The method of claim 15, further comprising the step of reformatting the first-in-time image data that is stored in the first image capture buffer prior to displaying the first-in-time image data on the image device display.

20. The method of claim 19, further comprising the step of storing the reformatted first-in-time image data in an image display buffer prior to displaying the first-in-time image data on the image device display.

21. The method of claim 15 further comprising the steps of enhancing the first-in-time image data that is stored in the first image capture buffer prior to displaying the first-in-time image data on the image device display and reformatting the first-in-time image data that is stored in the first image capture buffer prior to displaying the first-in-time image data on the image device display.

22. The method of claim 16, further comprising the step of enhancing the second-in-time image data that is stored in the second image capture buffer prior to displaying the second-in-time image data on the image device display.

23. The method of claim 22, further comprising the step of storing the enhanced second-in-time image data in an image display buffer prior to displaying the second-in-time image data on the image device display.

24. The method of claim 16, further comprising the step of reformatting the second-in-time image data that is stored in the second image capture buffer prior to displaying the second-in-time image data on the image device display.

25. The method of claim 24, further comprising the step of storing the reformatted second-in-time image data in an image display buffer prior to displaying the second-in-time image data on the image device display.

26. The method of claim 16 further comprising the steps of enhancing the first-in-time and second-in-time image data that is stored in the first and second image capture buffers, respectively, prior to displaying the first-in-time and second-in-time image data on the image device display, respectively and reformatting the first-in-time and second-in-time image data that is stored in the first and second image capture buffer, respectively, prior to displaying the first-in-time and second-in-time image data on the image device display, respectively.

27. The method of claim 26, further comprising the step of storing the enhanced and reformatted first-in-time and second-in-time image data in an image display buffer prior to displaying the first-in-time and second-in-time image data on the image device display.
